(19) United States
(12) Patent Application Publication
(10) Pub. No.: US 2013/0188536 A1
(43) Pub. Date: Jul. 25, 2013

(54) Full-Duplex Bandwidth Deployment

(71) Applicants: Juho Mikko Oskari Pirskanen, Kangasala (FI); Sami-Jukka Hakola, Kempele (FI); Juha P. Karjalainen, Olu (FI); Timo K. Koskela, Oulu (FI); Samuli Turtinen, Il (FI)

(72) Inventors: Juho Mikko Oskari Pirskanen, Kangasala (FI); Sami-Jukka Hakola, Kempele (FI); Juha P. Karjalainen, Olu (FI); Timo K. Koskela, Oulu (FI); Samuli Turtinen, Il (FI)

(73) Assignee: Renesas Mobile Corporation

(21) Appl. No.: 13/363,552

(22) Filed: Feb. 1, 2012

(30) Foreign Application Priority Data
Jan. 20, 2012 (GB) 1200971.8

(51) Int. Cl. H04W 72/04

(52) U.S. Cl. 370/281

(57) ABSTRACT

The specification and drawings present a new method, apparatus and software related product (e.g., a computer readable memory) for configuring/implementing full-duplex communications between UEs and a network on a partial frequency domain in wireless communications, e.g., in LTE systems. This may allow UEs with different transmission capabilities to operate on the same deployment bandwidth and to use time dependence of an operational mode. According to an embodiment, a network element, such as eNB, may configure a deployment bandwidth in a frequency domain for wireless communications between UEs and the network, wherein one or more full-duplex regions of the deployment bandwidth are allocated for full-duplex communications and one or more half-duplex regions of the deployment bandwidth are allocated for half-duplex communications.

### TECHNICAL FIELD

The exemplary and non-limiting embodiments of this invention relate generally to wireless communications and more specifically to utilizing full-duplex on a partial frequency domain in wireless communications, e.g., in LTE systems.

### BACKGROUND ART

The following abbreviations that may be found in the specification and/or the drawing figures are defined as follows:

3GPP 3^{rd} generation partnership project

AP access point

BTS base transceiver station

CA carrier aggregation

CDM code division multiplexing

D2D device-to-device

DL downlink

E-UTRA evolved universal terrestrial radio access

eNB, eNodeB evolved Node B/base station in an E-UTRAN system

E-UTRAN evolved UTRAN (LTE)

FDM frequency division multiplexing

FDD frequency division duplex

GSM global system for mobile communications

LTE long term evolution

LTE-A long term evolution advanced

MIB management information base

MIMO multiple input multiple output

MME mobility management entity

MTC machine type communication

PRB physical resource block

PRACH physical random access channel

PRB physical resource block

RRC radio resource control

Rx, RX reception, receiver

SIB system information block

TDD time division duplex

TDM time division multiplexing

Tx, TX transmission, transmitter

UE user equipment

UP uplink

UTRAN universal terrestrial radio access network

WCDMA wideband code division multiple access

WIMAX worldwide interoperability for microwave access

WLAN wireless local area network

Recently, full-duplex communications have attracted a lot of interest to enhance spectral efficiency in local area communications. The full-duplex communications are based on the principle in which radios can transmit and receive simultaneously on the same frequency band resulting in a self-interference problem. The self-interference problem is mainly caused by the large imbalance between the transmitted signal power and received signal power. Typically, the transmitted signal power can be a few orders of magnitude larger than the received signal power. As a result, the received signal may be severely degraded by its own transmitted signal.

General background for the recent full duplex studies can be found from the following references:
Jung II Choi, Mayank Jainy, Kannan Srinivasany, Philip Levis, Sachin Katti, “Achieving Single Channel, Full Duplex Wireless Communication”, In the Proceedings of the 16th Annual International Conference on Mobile Computing and Networking (Mobicom, held Chicago, Ill., USA, Sep. 20-24, 2010);
Melissa Duarte and Ashutosh Sabharwal, “Full-Duplex Wireless Communications Using Off-The-Shelf Radios: Feasibility and First Results”, in the Proceedings of the 44^{th} annual Asilomar conference on signals, systems, and computers (held in Nov. 7-10, 2010 in Monterey, Calif., USA);
Melissa Duarte, Chris Dick and Ashutosh Sabharwal “Experiment-driven Characterization of Full-Duplex Wireless Systems”, Submitted to IEEE Transactions on Wireless Communications, July 2011; (The paper can be found in the following link: http://arxiv.org/abs/1107.1276);
Evan Everett, Melissa Duarte, Chris Dick, and Ashutosh Sabharwal “Empowering Full-Duplex Wireless Communication by Exploiting Directional Diversity”, accepted to the 45^{th} annual Asilomar conference on signals, systems, and computers (held in Nov. 7-10, 2010 in Monterey, Calif., USA); and
Achaleshwar Sahai, Gaurav Patel and Ashutosh Sabharwal “Pushing the limits of Full-duplex: Design and Real-time Implementation”, Rice University technical report TREE1104, February 2011. (The paper can be found in the following link: http://warp.rice.edu/trac/wiki/TechReport2011_FullDuplex)

It may be assumed that in future cellular networks access points and devices will support full-duplex transmission. However, due to the different types of devices on the market, not all of the devices may support full-duplex transmission due to the cost issue (e.g., low capability phones) or the pre-determined service/traffic type (e.g. MTC-devices).

For the overall system performance point of view it would be beneficial to support full duplex for the so-called high end, high transmission capability devices which require such transmission scheme for their current services and at the same time support the non-full-duplex devices.

### SUMMARY

According to a first aspect of the invention, a method comprising: configuring by a network a deployment bandwidth in a frequency domain for wireless communications between user equipments and the network, wherein one or more full-duplex regions of the deployment bandwidth are allocated for full-duplex communications and one or more half-duplex regions of the deployment bandwidth are allocated for half-duplex communications; and communicating with the user equipments on the configured deployment bandwidth.

According to a second aspect of the invention, an apparatus comprises: at least one processor and a memory storing a set of computer instructions, in which the processor and the memory storing the computer instructions are configured to cause the apparatus to: configure a deployment bandwidth in a frequency domain for wireless communications between user equipments and the network, wherein one or more full-duplex regions of the deployment bandwidth are allocated for full-duplex communications and one or more half-duplex regions of the deployment bandwidth are allocated for half-duplex communications; and communicate with the user equipments on the configured deployment bandwidth.

According to a third aspect of the invention, a computer readable medium comprising a set of instructions, which, when executed on an apparatus in a network causes the apparatus to perform the steps of: configuring a deployment bandwidth in a frequency domain for wireless communications between user equipments and the network, wherein one or more full-duplex regions of the deployment bandwidth are allocated for full-duplex communications and one or more half-duplex regions of the deployment bandwidth are allocated for half-duplex communications; and code for communicating with the user equipments on the configured deployment bandwidth.

### BRIEF DESCRIPTION OF THE DRAWINGS

For a better understanding of the nature and objects of the present invention, reference is made to the following detailed description taken in conjunction with the following drawings, in which:

FIGS. 1-2 are frequency diagrams demonstrating bandwidth deployment for a partial full-duplex operation, according to exemplary embodiments of the invention;

FIG. 3 is a flow chart demonstrating implementation of exemplary embodiments of the invention performed by a network element (e.g., eNB); and

FIG. 4 is a block diagram of wireless devices for practicing exemplary embodiments of the invention.

### DETAILED DESCRIPTION

A new method, apparatus, and software related product (e.g., a computer readable memory) are presented for configuring/implementing full-duplex communications between UEs and a network on a partial frequency domain in wireless communications, e.g., in LTE systems. This may allow UEs with different transmission capabilities to operate on the same deployment bandwidth and to use time dependence of an operational mode.

The embodiments described herein may apply to future TDD based cellular systems, like LTE-A. Also FDD systems may also be used based on the embodiments described herein. In addition to 3GPP cellular systems such as GSM and WCDMA, the technique may be also applicable to IEEE systems defined by 802.11 (WLAN) and 802.16 (WIMAX). In general, the invention may be applicable (depending on the technical challenges) to cellular macro and micro deployments and maybe even more applicable to local area deployments such as femto, pico and body area networks. D2D communication may be also considered to be one application area for the full-duplex.

According to an embodiment of the invention, a network element, such as eNB, may configure a deployment bandwidth in a frequency domain for wireless communications between UEs and the network, wherein one or more full-duplex regions of the deployment bandwidth are allocated for full-duplex communications and one or more half-duplex regions of the deployment bandwidth are allocated for half-duplex communications.

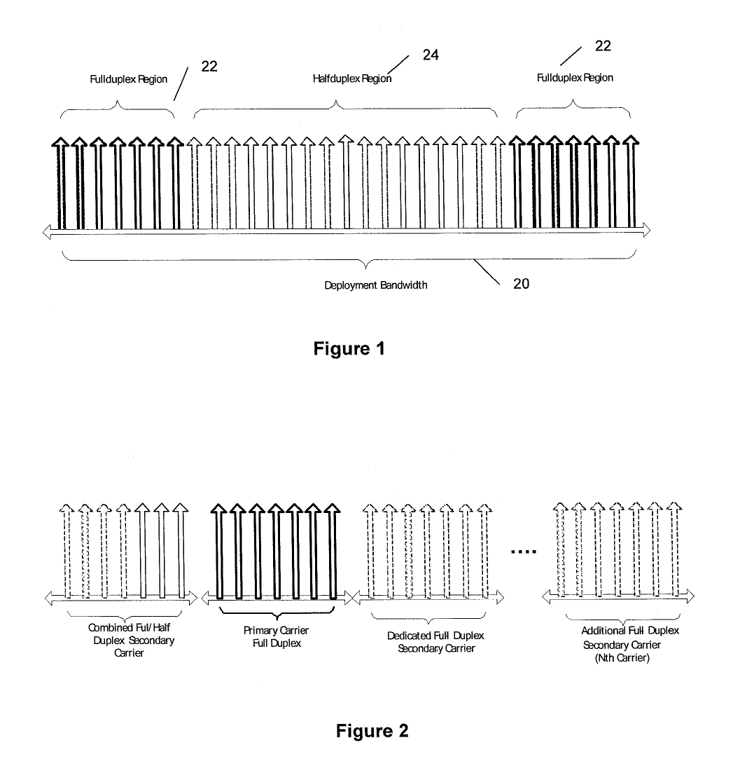

For example, in one embodiment the full-duplex transmission may be used on the partial resources on the deployment bandwidth, as illustrated in the exemplary FIG. 1, where the full duplex regions 22 are located at edges of the deployment bandwidth 20 and the half-duplex region 24 is located in the middle of the deployment bandwidth 20. Alternatively, the half-duplex regions may be located at the edges of the deployment bandwidth 20 with the full-duplex regions in the middle. Also, the deployment bandwidth may comprise a plurality of the full-duplex regions and/or a plurality of the half-duplex regions. In general, the deployment bandwidth may comprise one or more full-duplex regions and/or one or more half-duplex regions at arbitrary positions in the deployment bandwidth.

In one further embodiment the network may configure the control channels (e.g., uplink feedback channels or DL scheduling channels) for the half-duplex devices to the half-duplex region/regions and separately the full-duplex control channels for the full-duplex devices to the full-duplex region/regions.

It is further noted that each full-duplex region or each half-duplex region in the deployment bandwidth may comprise one or more multiple component carriers.

Moreover, in a further embodiment the network may aggregate multiple component carriers, possibly at different bandwidths regions, to be used for the full-duplex or half-duplex communications. The aggregated carriers for full-duplex and half-duplex communications may be either contiguous or non-contiguous in a frequency domain. As a result of carrier aggregation enabling the full-duplex communication, the utilization of available frequency spectrum may be further enhanced.

FIG. 2 illustrates an embodiment, wherein the deployment possibilities using primary and secondary carriers are utilized. The deployment may comprise multiple secondary carriers which are configured to be either half duplex, full-duplex or combined full/half-duplex. Thus, each of the one or more full-duplex regions and the one or more half-duplex regions may be allocated as a primary carrier, a secondary carrier, or further divided into a combination of primary and secondary carriers.

In one further non-limiting embodiment the deployment bandwidth allocation may be used in an UL band/phase of the system to keep, for example, communication properties of legacy UE devices substantially similar and to enable any added receiver complexity to be implemented at eNB/AP/BTS side. Furthermore, this mode of operation may provide that each UE receives and transmits in a normal TDD fashion, i.e., transmitted and received signals never collide, and only the eNB/AP/BTS supporting full duplex operation may receive transmission from one UE device and simultaneously transmit to another UE device on a DL band/phase. In this embodiment at least a portion of the deployment bandwidth is allocated separately for the UEs and a network device, like eNB/AP/BTS, communicating with the UEs. In this manner the network device may be configured for the full-duplex communications and a portion or all of the UEs may be configured for the half-duplex communications. Thus

the network device/element like eNB may be configured only for the full-duplex communications with the UEs. In another embodiment the network may configure a time domain utilization of the full-duplex operation (in addition to the frequency domain utilization). For example, the network may configure subframes in the full-duplex region (e.g., in LTE-A system) to be full-duplex subframes or half-duplex subframes in time domain. Also, different UE groups may have different full-duplex time periods.

Moreover, the information about the time domain utilization of the full-duplex operation may be configured by the network and provided to the UEs via system information broadcast such as SIB and/or MIB in LTE, or with the user specific control signaling such as RRC signaling.

Alternatively, the network may inform the UEs via system information which time domains utilize the non-full duplex (half-duplex) mode and by extension the UEs will also know when the full-duplex mode is to be in effect.

The network may configure deployment bandwidth allocations for the UEs, described herein, via system information.

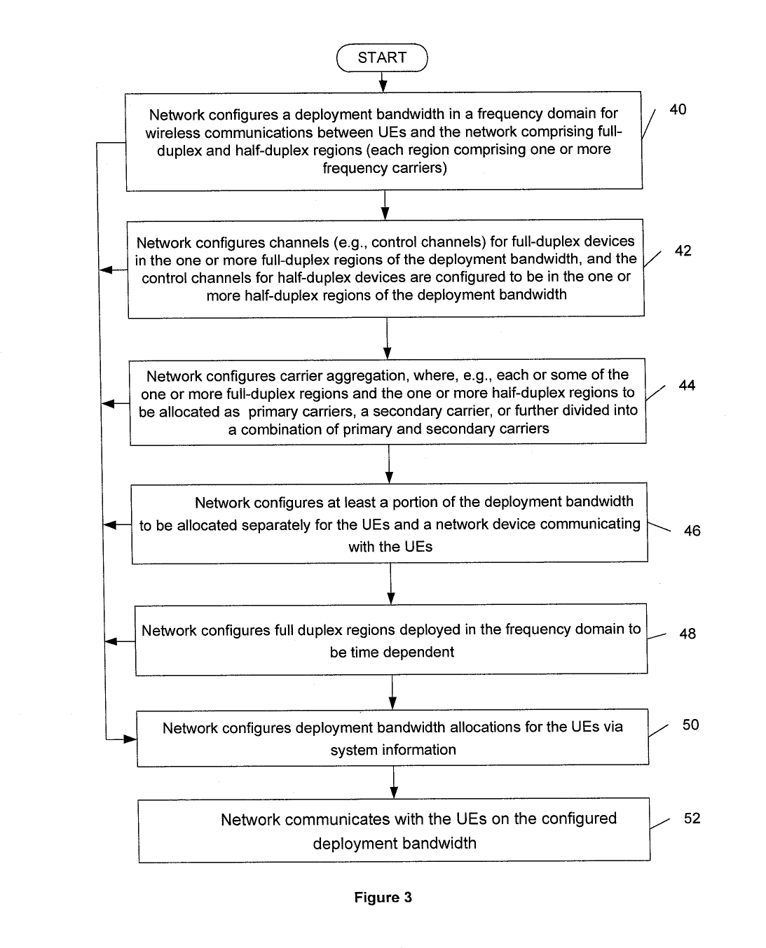

FIG. 3 shows an exemplary flow chart demonstrating configuring by the network a deployment bandwidth in a frequency domain for wireless communications between UEs and the network according to exemplary embodiments disclosed herein. It is noted that the order of steps shown in FIG. 3 is not required, so in principle the various steps may be performed out of the illustrated order. Also certain steps may be skipped, different steps may be added or substituted, or selected step/steps or groups of steps may be performed separately.

In a method according to this exemplary embodiment, as shown in FIG. 3, in a first step 40, the network configures a deployment bandwidth in a frequency domain for wireless communications between UEs and the deployment bandwidth comprises full-duplex and half-duplex regions (each region may comprise one or more frequency carriers), as described herein and shown, e.g., in FIGS. 1 and 2.

In a next step 42, the network configures channels (e.g., control channels) for the full-duplex devices in the one or more full-duplex regions of the deployment bandwidth, and the control channels for half-duplex devices are configured to be in the one or more half-duplex regions of the deployment bandwidth.

In a next step 44, the network configures carrier aggregation, where, for example, each or some of the one or more full-duplex regions and the one or more half-duplex regions to be allocated as a primary carrier, a secondary carrier, or further divided into a combination of primary and secondary carriers, as described herein and illustrated in FIG. 2.

In a next step 46, the network allocates to UEs at least one half-duplex region for UL only, and the network utilizes the at least one allocated half-duplex region as full-duplex.

In a next step 48, network configures at least a portion of the deployment bandwidth in the frequency domain to be time dependent, e.g., the full-duplex regions deployed in the frequency domain may be time dependent.

The results of the deployment bandwidth allocations presented in steps 42-48 in FIG. 3 may be configured by the network to the UE via system information in step 50. In a next step 52, the network communicates with the UEs using the configured deployment bandwidth.

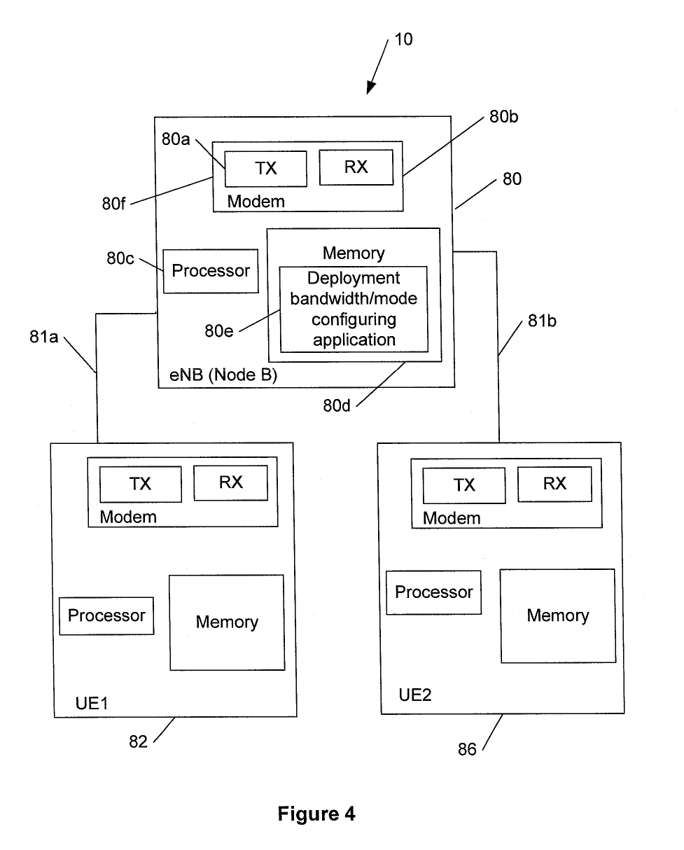

FIG. 4 shows an example of a block diagram demonstrating LTE devices including an eNB 80 comprised in a network 10, and UE1 82 and UE2 86, according to an embodiment of the invention. FIG. 4 is a simplified block diagram of various electronic devices that are suitable for practicing the exemplary embodiments of this invention, e.g., in reference to FIGS. 1-3, and a specific manner in which components of an electronic device are configured to cause that electronic device to operate. Each of the UEs 82 and 86 may be implemented as a mobile phone, a wireless communication device, a camera phone, a portable wireless device and the like.

The eNB 80 may comprise, e.g., at least one transmitter 80a at least one receiver 80b, at least one processor 80c at least one memory 80d and a deployment bandwidth configuring application module 80e. The transmitter 80a and the receiver 80b and corresponding antennas (not shown in FIG. 4) may be configured to provide wireless communications with the UEs 82 and 86 (and others not shown in FIG. 4) according to the embodiment of the invention. The transmitter 80a and the receiver 80b may be generally means for transmitting/receiving and may be implemented as a transceiver, or a structural equivalence (equivalent structure) thereof. It is further noted that the same requirements and considerations are applied to transmitters and receivers of the devices 82 and 86.

Furthermore, the eNB 80 may further comprise communicating means such as a modem 80f, e.g., built on an RF front end chip of the eNB 80, which also carries the TX 80a and RX 80b for bidirectional wireless communications via data/control/broadcasting wireless links 81a and 81b with the UEs 82 and 86. The same concept is applicable to UE devices 82 and 86 shown in FIG. 4.

Various embodiments of the at least one memory 80d (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 80c include but are not limited to general purpose computers, special purpose computers, microprocessors, digital signal processors (DSPs) and multi-core processors. Similar embodiments are applicable to memories and processors in other devices 82 and 86 shown in FIG. 4.

The deployment bandwidth/mode configuring application module 80e may provide various instructions for performing steps 40-50 in FIG. 3. The module 80e may be implemented as an application computer program stored in the memory 80d, but in general it may be implemented as software, firmware and/or hardware module or a combination thereof. In particular, in the case of software or firmware, one embodiment may be implemented using a software related product such as a computer readable memory (e.g., non-transitory computer readable memory), computer readable medium or a computer readable storage structure comprising computer readable instructions (e.g., program instructions) using a computer program code (i.e., the software or firmware) thereon to be executed by a computer processor.

Furthermore, the module 80e may be implemented as a separate block or may be combined with any other module/block of the eNB 80, or it may be split into several blocks according to their functionality.

The UE1 82 and UE2 86 may have similar components as the eNB 80, as shown in FIG. 5, so that the above discussion about components of the eNB 80 is fully applicable to the components of the UE1 82 and UE2 86,

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

1. A method, comprising:
configuring by a network a deployment bandwidth in a frequency domain for wireless communications between user equipments and the network, wherein one or more full-duplex regions of the deployment bandwidth are allocated for full-duplex communications and one or more half-duplex regions of the deployment bandwidth are allocated for half-duplex communications; and
communicating with the user equipments on the configured deployment bandwidth.

2. The method of claim 1, wherein the configured deployment bandwidth comprises two full-duplex regions located at opposed edges of the deployment bandwidth.

3. The method of claim 1, wherein the configured deployment bandwidth comprises two half-duplex portions located at opposed edges of the deployment bandwidth.

4. The method of claim 1, wherein the configured deployment bandwidth comprises a plurality of the full-duplex regions.

5. The method of claim 1, further comprising configuring control channel for full-duplex devices to be in the one or more full-duplex regions of the deployment bandwidth and for half-duplex devices to be in the one or more half-duplex regions of the deployment bandwidth.

6. The method of claim 1, wherein each full-duplex region or each half-duplex region in the deployment bandwidth comprises one or more component carriers.

7. The method of claim 1, further comprising configuring carrier aggregation, wherein each or some of the one or more full-duplex regions and the one or more half-duplex regions are allocated as a primary carrier, a secondary carrier, or further divided into a combination of primary and secondary carriers.

8. The method of claim 1, wherein at least one region of the deployment bandwidth is allocated as a half-duplex region to all or some of the user equipments for uplink communications and as a full-duplex region for a network device communicating with the all or some of the user equipments.

9. The method of claim 1, wherein a network device communicating with all or some of the user equipments is configured for the full-duplex communications and a part or all of the user equipments are configured for the half-duplex communications.

10. The method of claim 1, wherein an eNB of the network is configured only for the full-duplex communications with the user equipments.

11. The method of claim 1, further comprising configuring in a time domain the full-duplex regions deployed in the frequency domain.

12. The method of claim 11, wherein different groups of the user equipments are configured to have different full-duplex time periods.

13. An apparatus comprising:
at least one processor and a memory storing a set of computer instructions, in which the processor and the memory storing the computer instructions are configured to cause the apparatus to:
configure a deployment bandwidth in a frequency domain for wireless communications between user equipments and the network, wherein one or more full-duplex regions of the deployment bandwidth are allocated for full-duplex communications and one or more half-duplex regions of the deployment bandwidth are allocated for half-duplex communications; and
communicate with the user equipments on the configured deployment bandwidth.

14. The apparatus of claim 13, wherein the configured deployment bandwidth comprises two half-duplex portions located at opposed edges of the deployment bandwidth.

15. The apparatus of claim 13, wherein the computer instructions are further configured to cause the apparatus to:
configure control channel for full-duplex devices to be in the one or more full-duplex regions of the deployment bandwidth and for half-duplex devices to be in the one or more half-duplex regions of the deployment bandwidth.

16. (canceled)

17. The apparatus of claim 13, wherein at least one region of the deployment bandwidth is allocated as a half-duplex region to all or some of the user equipments for uplink communications and as a full-duplex region for a network device communicating with the all or some of the user equipments.

18. (canceled)

19. The apparatus of claim 13, wherein the computer instructions are further configured to cause the apparatus to:
configure in a time domain the full-duplex regions deployed in the frequency domain.

20. (canceled)

21. The apparatus of claim 13, wherein an eNB of the network is configured only for the full-duplex communications with the user equipments.

22. The apparatus of claim 13, wherein the apparatus comprises an eNB.

23. A computer readable medium comprising a set of instructions, which, when executed on an apparatus in a network causes the apparatus to perform the steps of:
configuring a deployment bandwidth in a frequency domain for wireless communications between user equipments and the network, wherein one or more full-duplex regions of the deployment bandwidth are allocated for full-duplex communications and one or more half-duplex regions of the deployment bandwidth are allocated for half-duplex communications; and
code for communicating with the user equipments on the configured deployment bandwidth.

24-28. (canceled)
